(19) United States
(12) Patent Application Publication
(10) Pub. No.: US 2025/0314525 A1
(43) Pub. Date: Oct. 9, 2025

(54) SYSTEM FOR MEASURING ROOM REVERB

(71) Applicant: GOOGLE LLC, Mountain View, CA (US)

(72) Inventors: Rajeev Nongpiur, Mountain View, CA (US); Tianyu Xu, Mountain View, CA (US)

(21) Appl. No.: 18/627,621

(22) Filed: Apr. 5, 2024

(51) Int. Cl. G01H 7/00

(52) U.S. Cl. CPC G01H 7/00

(57) ABSTRACT

Disclosed implementations for determining a reverb characteristic of an environment based on an impulsive sound generated within the environment. The impulsive sound is captured by an audio sensor. The impulsive sound is converted to a scale plotting a decay over time of a measure of sound waves of the impulsive sound. A diffused portion of the impulsive sound that includes the sound waves reflected from the environment is determined. The reverb characteristic of the environment is determined based on the magnitude of the diffused portion.

### BACKGROUND

Sound reproduction is the process of recording, processing, storing, and recreating sound, such as speech, music, and the like. When recording a sound, one or more audio sensors are used to capture sound in single or multiple positions for a recording device.

### SUMMARY

Implementations of the present disclosure are generally directed to determining a reverb characteristic of an environment (e.g., a room, a cubicle, a chamber, an alcove, a court, an entrance, a passage, and the like) based an impulsive sound (e.g., a clap, a knock, a slap, a stomp, a thump, a thunk [dropping an object], a clunk, a pop [popping a balloon], and the like) generated by a user and recorded on a device (e.g., a user device). The device can be a computing device (e.g., a mobile device, a laptop computing device, a head-mounted display (HMD) device, a mixed reality (XR) device such as an augmented reality (AR) and/or virtual reality (VR) device). These systems may receive sound data from an audio sensor (e.g., a microphone) and determine a reverb characteristic by converting the sound data to a scale (e.g., a decibel (dB) scale) plotting a decay over time of a measure (e.g., decibels) of the pressure waves recorded from the impulsive sound. For example, the scale shows how the recorded decibel level dropped over time from a peak until the impulsive sound blends in with the background noise in the environment. The system, based on the scaled sound data, identifies an initial portion, a diffused portion, and a background portion of the measured impulsive sound. The reverb characteristic of the environment is then determined based on a magnitude of the identified diffused portion. Accordingly, these systems may render spatial audio sounds that match the reverb characteristic of the environment by employing the reverb characteristic and thereby making the experience more immersive.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

The following detailed description that sets forth aspects of the subject matter, along with the accompanying drawings of which:

FIG. 1 is an example environment where a device is employed to determine a reverb characteristic of the environment, according to an implementation as the described reverb measuring system;

FIG. 2 is an example architecture that can be employed to execute implementations of the present disclosure;

FIG. 3 is a flowchart of a non-limiting process that can be implemented by implementations of the present disclosure;

FIGS. 4A and 4B are example architectures of the described reverb measuring system for processing an impulsive-sound signal received from the multiple audio sensors;

FIG. 5 is an example environment that can be employed to execute implementations of the present disclosure;

FIG. 6 is a flowchart of another non-limiting process that can be performed by implementations of the present disclosure; and

FIG. 7 is an example system that includes a computer or computing device that can be programmed or otherwise configured to implement systems or methods of the present disclosure.

### DETAILED DESCRIPTION

Rooms (e.g., environments) come in many shapes and sizes, and each of these spaces sound completely different. Structural elements, such as flat, parallel, and reflective boundaries, as well the objects within the room, cause sonic anomalies such as modal interference, standing waves, flutter echo, rings, and resonances. Moreover, because sound consists of pressure waves (sound waves), sound bounces around a room. In particular, sound waves can bounce off the floor, walls, ceiling, and any other reflective surface, gradually losing energy over time. Reverberation is the collection of these reflected sounds while reverberation time is the time, after the source of the sound has ceased, for the sound to fade away. Accordingly, a reverb characteristic is a measure of this reverberation (e.g., a measure of how sound travels and decays within the environment) that is calculated according to the reverberation time. The reverb characteristic can be used to emulate/render sounds in a particular environment.

Current approaches for measuring a reverb characteristic of an environment include projecting, via a device (e.g., a loudspeaker or a microphone), a sine sweep or white noise and deriving a series of reverb parameters to form the reverb characteristic. At least one technical problem with this approach is that the such an approach is not feasible for many types of user devices (e.g., a headset device, such as a head-mounted device, mobile devices, laptops, and the like) because the loudspeakers and audio sensors (e.g., microphones) associated with such devices are typically not loud enough or sensitive enough to capture the reverb effects. Another current approach includes computing the reverb parameters based on the dimensions and reflection coefficients of an environment identified using vision and depth sensors. However, at least one technical problem with such an approach are inaccuracies in the calculated reverb parameters. Moreover, the scanning of a space with a device takes a considerable amount of time and is not user-friendly as generating the reverb parameters via a model takes a multitude of user scans of the environment.

The implementations described herein provide at least one technical solution to these technical problems. In particular, implementations of the described system determine a reverb characteristic of an environment based on an impulsive sound generated by a user and recorded on a user device (e.g., audio sensors associated with the user device). The user device may employ the reverb characteristic to render spatial audio sounds matching the a reverb characteristic of the environment and thereby making the experience more immersive (e.g., when in pass-through mode). In some implementations, a user may receive a prompt from a user interface associated with a user device that includes instructions for how to generate an impulsive sound or a list of appropriate sounds to generate. The user may also receive a follow-up prompt when the impulsive sound is insufficiently loud enough to overcome the background noise. In some implementations, audio sensors associated with the user device are configured to capture the impulsive sound generated by the user within the environment.

The described reverb measuring system uses the captured sound data to determine a reverb characteristic of the environment. More specifically, the audio sensor is configured to generate a signal that includes a range of frequencies (e.g., temporal frequencies) captured from the impulsive sound and the interaction of the sound waves emitted from the source of the impulsive sound in the environment. The range of frequencies is converted to a scale (e.g., dB scale) plotting a decay over time of a measure (e.g., decibels) of the pressure waves of the impulsive sound. For example, the scale shows how the recorded decibel level dropped over time from a peak until the impulsive sound blends in with the background noise in the environment. The system, based on the scaled sound data, identifies an initial portion, a diffused portion, and a background portion of the measured impulsive sound. The reverb characteristic of the environment is then determined based on a magnitude of the identified diffused portion.

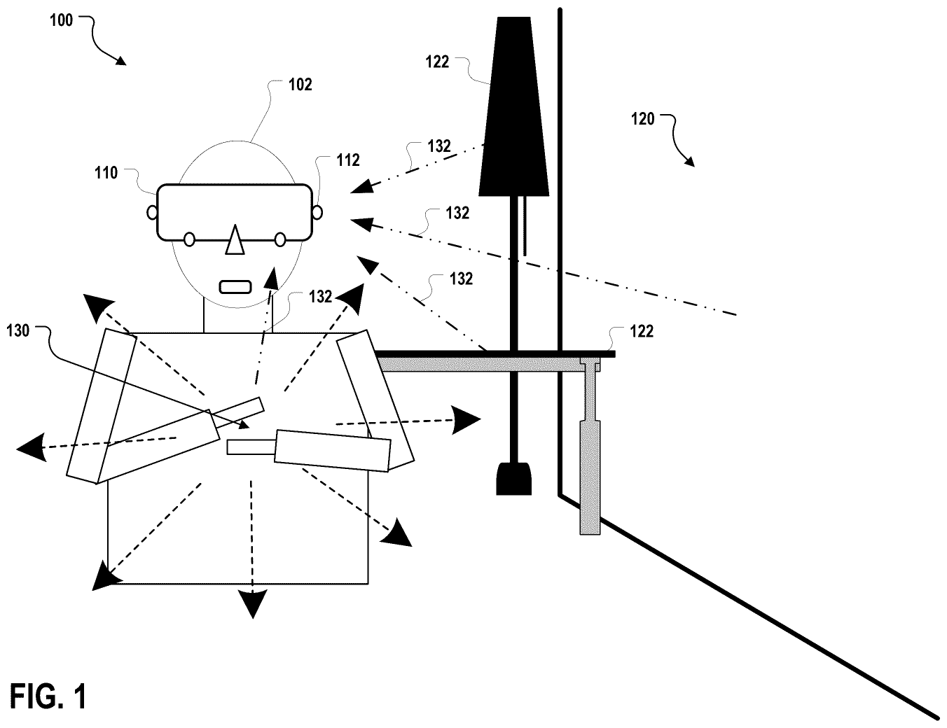

FIG. 1 shows an example environment 100 (e.g., a room) where a device 110 (e.g., a headset) having one or more audio sensors 112 (e.g., a microphone) is employed (e.g., by a user 102) to determine a reverb characteristic (e.g., including at least one reverb parameter, such as reverberation time (RT)-20 or RT60) of the environment 100 according to implementation of the described reverb measuring system. As depicted, the environment 100 includes features 122 and structural elements 120 (e.g., walls, floors, ceilings). FIG. 1 depicts the example environment 100 with two features 122, a lamp and a table; however, it is contemplated that implementations of the present disclosure can be realized within an environment having any number of features as well as any configuration of the respective structural elements 120.

As depicted in FIG. 1, the user 102 generates an impulsive sound. As used herein, the term “impulsive sound” refers to a sound of short duration, usually less than one second, with an abrupt onset and rapid decay. Typically, an impulsive sound has a wide frequency band. Examples of sources of impulsive sound include impacts (e.g., from dropping an object), a knock (e.g., on a table or a door), a clap, a slap, clicking, and the like. However, implementations of the present disclosure can be realized with sound having a decibel level about a configurable threshold above the background noise for the space where the sound originates, or the environment being measured.

For example, the user 102 may receive a prompt from a user interface of the device 110 that includes instructions for how to generate the impulsive sound or what kind of impulsive sound to generate (e.g., so that sound is able to be recorded by the audio sensors 112 and distinguishable from the background noise in the environment 100). In some cases, the user 102 may receive a follow-up prompt from the user interface of the device 110 that includes instructions to generate the impulsive sound again but louder (e.g., when the device 110 determines that the background noise is too high to pick up the previously generated impulsive sound). FIG. 1 depicts the user 102 generating the impulsive sound by clapping; however, it is contemplated that implementations of the present disclosure can be realized with any sort of impulsive sound generated by any number of ways, either by a user or some other object or device.

The audio sensors 112 are devices that are configured to detect sounds and convert the detected sounds into an electrical audio signal. Example audio sensors include, but are not limited to, microphones, piezoelectric sensors, and capacitive sensors. In some implementations, the audio sensors 112 are configured to capture/record samples from the sound waves 132 generated from the source 130 of the impulsive sound. These sound waves 132 may be captured by the audio sensors 112 directly from the source 130 or indirectly after having been reflected by one of the features 122 or structural elements 120. In some implementations, the audio sensors 112 are configured to generate a series of impulsive-sound signals based on the samples. In some implementations, the device 110 is configured to determine a reverb characteristic of the environment 100 based on the generated impulsive-sound signals.

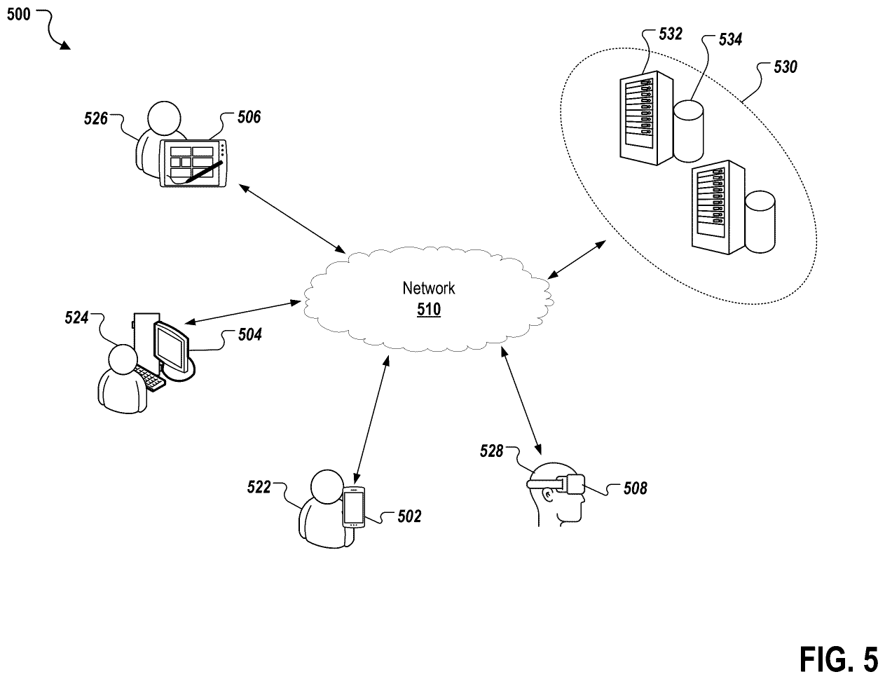

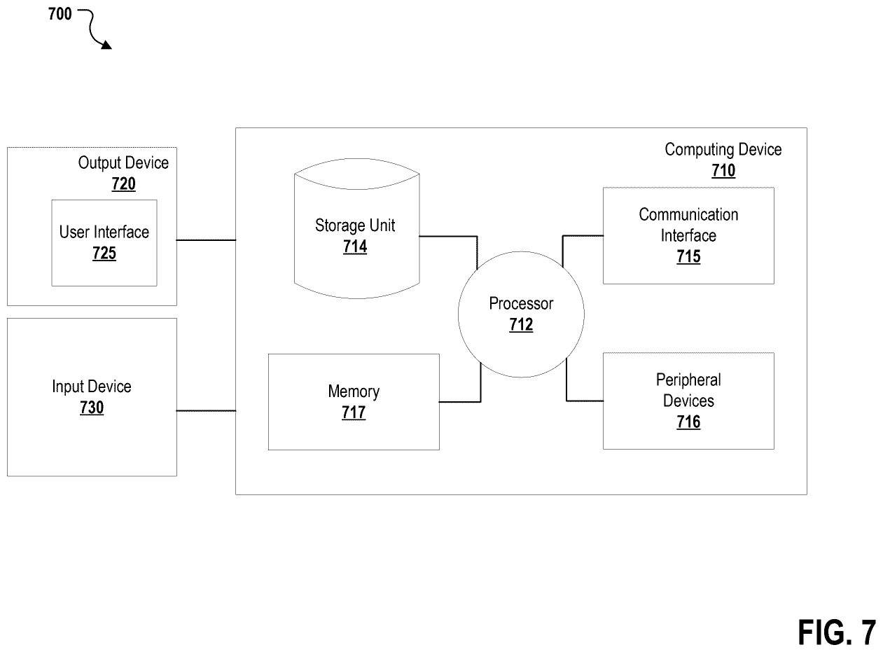

The device 110 is sustainably similar to computing device 710 depicted below with reference to FIG. 7. Moreover, in the figures and descriptions included herein, device 110 is an augmented reality (AR)/virtual reality (VR)/extended reality (XR) headset type device; however, it is contemplated that implementations of the present disclosure can be realized with any of the appropriate computing device(s), such as the user computing devices 502, 504, 506, and 508 described below with reference to FIG. 5.

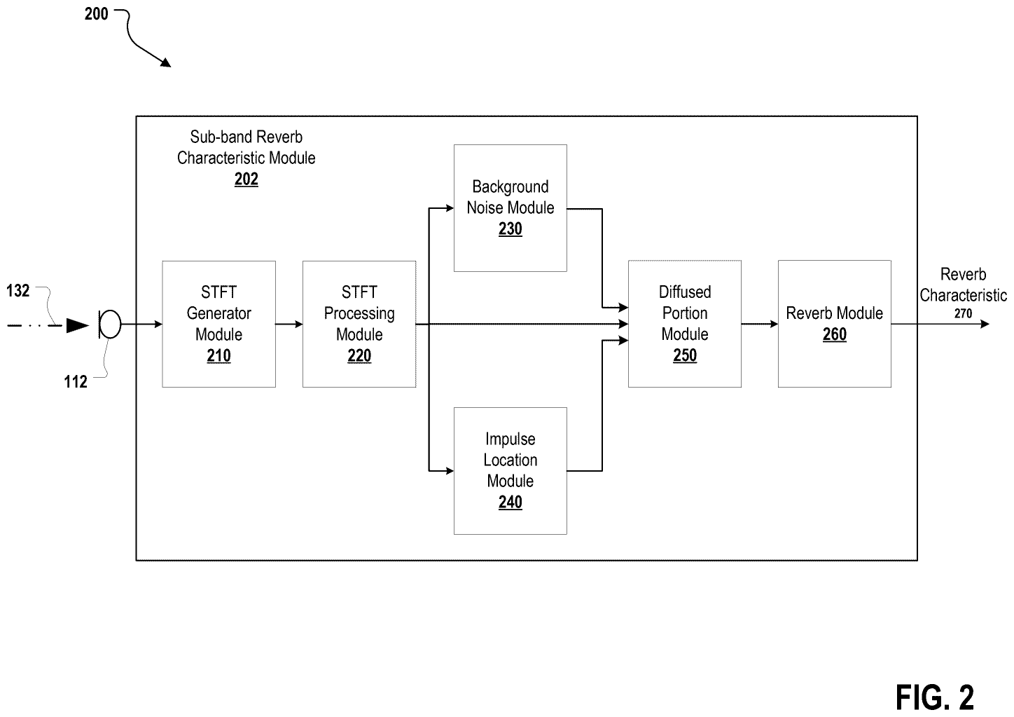

FIG. 2 is an example architecture 200 for the described reverb measuring system. As depicted, the example architecture 200 includes the audio sensor 112, and sub-band reverb characteristic module 202, which includes short-time Fourier transform (STFT) generator module 210, STFT processing module 220, background noise module 230, impulse location module 240, diffused portion module 250, and reverb module 260. In some implementations, the modules 202, 210, 220, 230, 240, 250, and 260 are executed via an electronic processor of the device 110, depicted with reference to FIG. 1. In some implementations, the modules 202, 210, 220, 230, 240, 250, and 260 are provided via a back-end system (such as the back-end system 530 described below with reference to FIG. 5) and the device 110 is configured to communicate with the back-end system via a network (such as the network 510 described below with reference to FIG. 5).

Generally, the sub-band reverb characteristic module 202 determines a reverb characteristic (e.g., also referred to herein as a sub-band reverb parameter) based on the impulsive-sound signal (e.g., a time domain signal) provided by the audio sensor 112. As described above, the reverb characteristic is a measure of the decay of a sound within the environment where the signal was recorded. An STFT is determined based on the impulsive-sound signal received from the audio sensor 112.

The STFT is determined for a range of frequencies included in the impulsive-sound signal. For example, in some cases, the STFT is determined for the full band of frequencies included in the impulsive-sound signal. In other cases, the full band of frequencies is divided into a series of sub-bands (see below) and the STFT is determined for each of the sub-bands (or a subset of the sub-bands). The magnitude of the STFT is determined and converted to a dB scale (e.g., according to a logarithmic scale). The STFT determines the sinusoidal frequency and phase content of sections of the range of frequencies with change over time. To state it another way, the STFT (once converted to dB scale) shows the rate of decay of the range of frequencies (e.g., the full band or a sub-band) in decibels over time. The STFT can then be processed to determine a reverb characteristic of the environment.

Once the STFT magnitude has been converted to the dB scale, the sub-band reverb characteristic module 202 determines a maximum magnitude or peak, an initial portion, a diffused portion, and a background portion of the temporal component at each sub-band frequency bin. Generally, the peak of the temporal component at each sub-band frequency bin represents the instant that the initial set of sound waves 132 generated from the source 130 of the impulsive sound are received by the audio sensor(s) 112. The initial portion is a temporal region represented in the STFT that includes the decay (in decibels) from the peak to the diffused portion. The rate of decay in the initial portion is greater than the rate of the decay in the diffused portion. To state another way, the slope of the initial portion (as shown in the STFT) is steeper than the slope of the initial portion. The diffused portion is a temporal region represented in the STFT where the impulsive sound is approximately diffused (e.g., region of the reverb) that provides information related to the reverb properties of the environment where the signal was recorded. The background noise portion is represented in the STFT where the impulsive sound becomes indistinguishable from the background noise in the environment. Background noise (or ambient noise) includes sounds other than the sound being monitored (e.g., the impulsive sound) and includes, for example, environmental noises such as water waves, traffic noise, alarms, extraneous speech, bio-acoustic noise, electrical noise from devices, and the like. The sub-band reverb characteristic module 202 processes the diffused portion or an extrapolated diffused portion (see below) to determine a reverb characteristic for the environment.

In some implementations, the reverb characteristic is determined for the band of frequencies (full band) included in the signal (e.g., between 20 hertz [Hz] to 20 kilohertz [kHz]). In other implementations, the band of frequencies is divided into a series of sub bands and a reverb characteristic is determined for each of the sub bands or for a number a sub bands within a set frequency range (e.g., the sub-bands that include the frequencies between 200 kHz and 2 kHz). In some cases, for example, the band of frequencies in the signal may be divided uniformly into sub bands where each sub band has the same bandwidth of frequency range (e.g., 1 hz, 2 hz, 3 hz, and so forth up to about 5 kHz) or from, for example, three to one hundred plus sub bands. In other cases, the band of frequencies in the signal may be divided by scaling the bandwidth of frequency range in each sub band according to a set metric (e.g., human hearing). For example, human hearing can discern more information at lower frequencies. Accordingly, the lower frequencies sub bands may include a smaller range of frequency, which is increased for each sub band according to a set metric (e.g., 1 hz) as the frequency climbs. In some implementations, the band of frequencies is divided into a number of frequency bins (e.g., 128) and each sub band is assigned as set number of frequency bins (e.g., 4 bin) or a scale number of frequency bins based on the frequency (e.g., lower frequency bands are assigned 1-2 bins which scale up to 12 to 16 bins for the higher frequency bands).

In the depicted example architecture 200, the STFT generator module 210 processes the impulsive-sound signal received from the audio sensor 112. In some cases, the STFT generator module 210 divides the band of frequencies included in the signal as described above. The STFT generator module 210 processes the signal or sub band(s) of the impulsive-sound signal to determine the STFT by dividing the signal or sub band into shorter segments of equal length and computing the Fourier transform separately on each segment to reveal the Fourier spectrum on each segment. Stated another way, each segment information related to the respective frequency spectrum at a particular point in time. The changing spectra are then plotted as a function of time (e.g., as a spectrogram or waterfall plot). In some implementations, the STFT processing module 220 determines the magnitude of the SFTF, which is converted to a dB scale by taking the log of the magnitude of the STFT. The STFT is converted to dB scale, which shows the decay over time in decibels of the signal in the respective range of frequencies and denotes the peak, initial portion, diffuse portion, and background portion regions.

The background noise module 230 determines the location of the background region in the STFT for the environment. Example methods that may be employed by the background noise module 230 to determine the location of the background region include, but are not limited to, thresholding, spectral subtraction, wiener filtering, and deep neural networks (DNNs). In some examples, thresholding includes setting a threshold level for the amplitude of the audio signal where sounds below the threshold are considered noise. In some examples, spectral subtraction includes estimating the noise spectrum by analyzing silent portions of the audio and then subtracts these silent portions from the overall spectrum. In some examples, wiener filtering employs an adaptive filter to estimate the noise spectrum, which is subtracted from the signal. In some examples, DNNs are trained to identify and remove background noise in various situations. DNNs are typically trained with large datasets, provide high accuracy, and can handle complex noise patterns.

The impulse location module 240 determines the location of the peak of the impulse response (e.g., the starting location of the magnitude) in the SFTF. In some implementations, the impulse location module 240 identifies the location of the impulse by determining the temporal location where the energy (across the full band or sub-band) is maximum. In some environments, only the energy of the higher-frequency portion of the spectrum is considered for more accurate estimation where there is significant low-frequency background noise.

The diffused portion module 250 determines the location of the diffused portion in the SFTF and a magnitude of the diffused portion based on the location of the peak and the location of the background portion in the STFT. In some implementations, the diffused portion module 250 determines the starting location of the diffused portion in the STFT according to the location of the peak and a configurable number of decibels (e.g., 5-20 dB from the peak). In other implementations, the diffused portion module 250 determines the starting location of the diffused portion according to the slope and a threshold value (e.g., find the area where the slope, as measured from the peak, tapers by a set threshold, and marks the starting location of the diffused portion and the ending location of the initial portion).

The diffused portion module 250 determines an ending location for the diffused portion in the STFT according to the number/amount of decibel necessary for the measure of decay of the reverb parameter. For example, when providing a reverb parameter with a RT60 measure of decay, the ending location of the diffused portion is determined as 60 dB below the starting location (or 20 dB below the starting location with a RT20 measure of decay, 90 dB below the starting location with a RT90 measure of decay, and so forth).

In some cases, the distance (e.g., decibels over time) between the starting location of the diffused portion and the starting location of the background noise or an offset location, which is determined based on starting location of the background noise plus an offset value (e.g., between 1 dB to 10 dB), is less than the measure of decay of the reverb parameter. For example, when providing a reverb parameter with a RT60 measure of decay, the starting location of the diffused portion and the starting location of the background noise (or the offset location) may only include a decay of 15 dB. In such cases, the ending location for the diffused portion may be set to the starting location of the background noise or the offset location. The offset value is employed to distinguish the decay of the impulse magnitude from the background noise and may be configured based on, for example, the type or quality of the sensors 112, the type of device 110, the reverb parameter, and the like.

Once the diffused portion is determined (based on the starting and ending locations), the diffused portion module 250 determines the magnitude of the diffused portion (e.g., how much time passed between the starting and ending of the diffused portion. The reverb module 260 generates a reverb parameter for the environment (e.g., RT60) based on the magnitude of the diffused portion in the STFT.

In some cases, the distance (decibels over time) between the starting location and the ending location of the diffused portion is less than the measure of decay of the reverb parameter.

In such cases, the reverb module 260 may extrapolate the remaining decibels for the output. For example, in some implementations, a linear regression model is applied to the diffused portion to extrapolate additional data and generate an extrapolated diffused portion having the number/amount of decibels necessary for the output reverb parameter based on the original diffused portion and additional data. Continuing with the example above, a diffuse decay of the decibels between the starting location and the ending location of the diffused portion is measured as 15 dB over 200 milliseconds (ms). A decay of the remaining 45 decibels is then extrapolated by applying a linear regression model to the measured data to determine an extrapolated diffused portion (e.g., a decay of the remaining 45 dB over 600 ms). The reverb module 260 then generates a reverb parameter for the environment (e.g., RT60) based on the magnitude of the diffused portion and the extrapolated diffused portion. In some implementations, the linear regression model includes applying/fitting a linear curve to the data. In some implementations, the linear fit is applied to the diffused portion in log scale.

In some examples, the reverb module 260 determines a per-frequency impulse decay-rate based on the diffused portion (or the diffused portion and the extrapolated diffused portion). From the decay rate, the reverb module 260 then determines the reverb parameters, such as RT20 or RT60, for each sub-band (sub-band reverb characteristic) included in the band of frequencies from the signal received from the audio sensor 112.

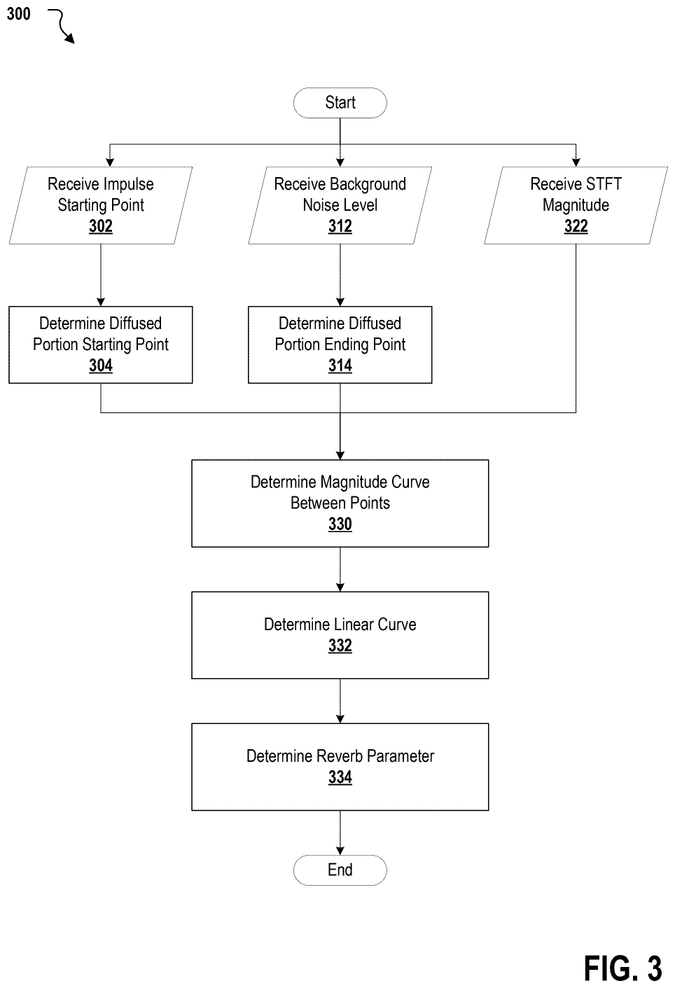

FIG. 3 is a flowchart of an example process 300 that can be implemented by implementations of the present disclosure. The example process 300 can be implemented by systems and components described with reference to FIGS. 1, 2, 4A-5, and 7. The example process 300 generally shows in more detail how the sub-band reverb characteristic module 202 determines a reverb parameter for a sub-band.

For clarity of presentation, the description that follows generally describes the example process 300 in the context of FIGS. 1, 2, and 4A-6. However, it will be understood that the process 300 may be performed, for example, by any other suitable system, environment, software, and hardware, or a combination of systems, environments, software, and hardware as appropriate. In some implementations, various operations of the process 300 can be run in parallel, in combination, in loops, or in any order.

At 302, the location of the peak of the impulse response for the sub-band is received from the impulse location module 240. From 302, the process 300 proceeds to 304 where the diffused portion module 250 determines the starting location of the diffused portion.

At 312, the diffused portion module 250 receives the location of the background noise for the sub-band from the background noise module 230. From 312, the process proceeds to 314 where the diffused portion module 250 determines the ending location of the diffused portion.

At 322, the diffused portion module 250 receives the magnitude of the SFTF for the sub-band from the STFT processing module 220.

From 304, 314, and 322 the process 300 proceeds to 330 where the diffused portion module 250 determines the magnitude curve between the starting location and the ending location of the diffused portion. From 330, the process 300 proceeds to 332 where the diffused portion module 250 applies a linear regression model to the magnitude curve between the starting location and the ending location of the diffused portion to determine an extrapolated diffused portion having the number/amount of decibels necessary for the output reverb parameter. From 332, the process 300 proceeds to 334 where the diffused portion module 250 determines the reverb parameter for a sub-band.

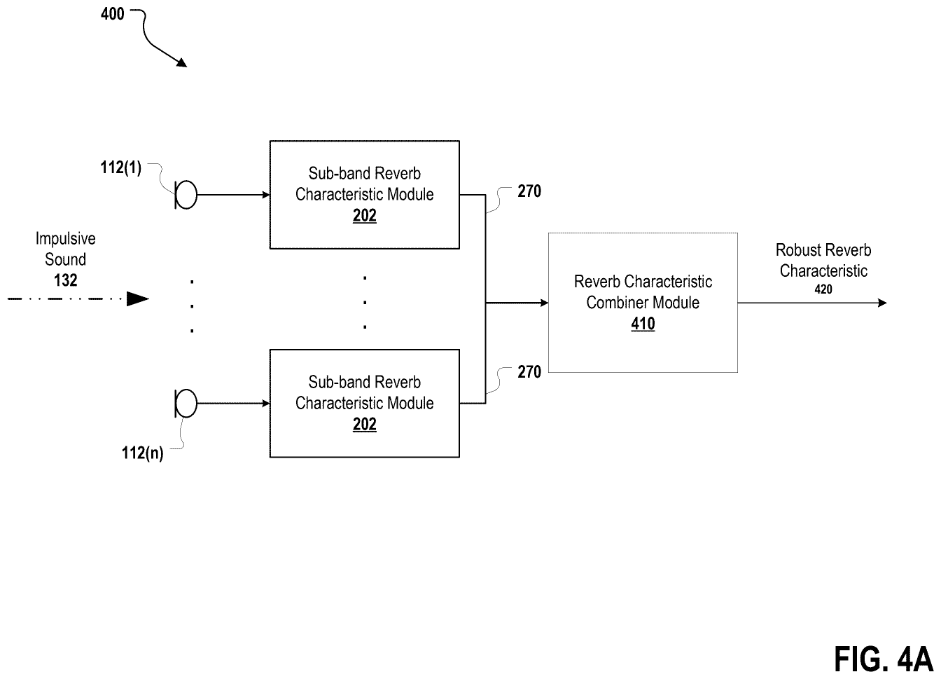

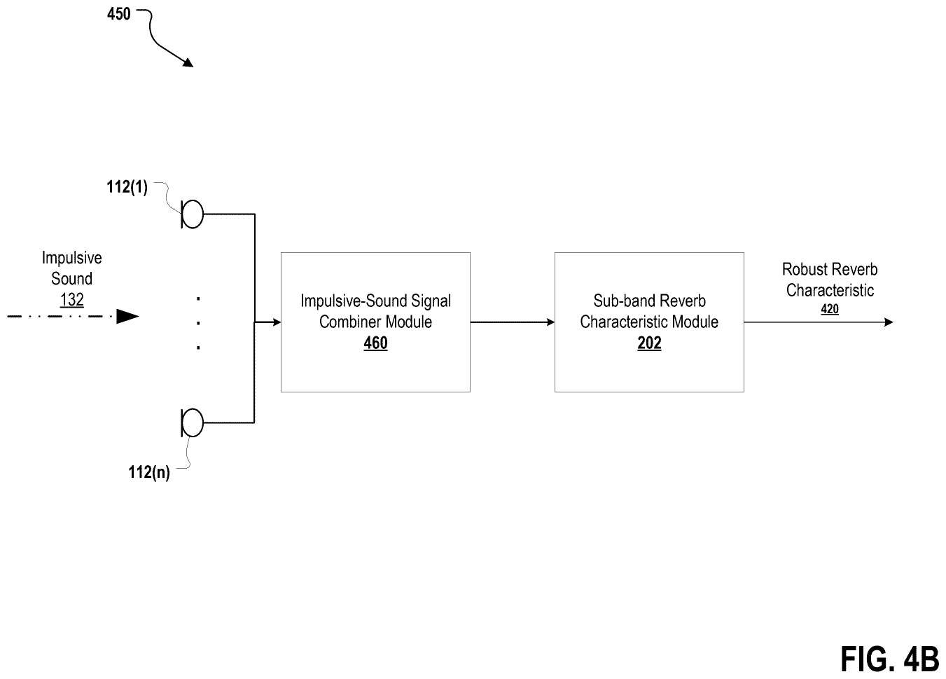

FIG. 4A is an example architecture 400 for the described reverb measuring system where the sub-band reverb characteristic module 202 is employed to process the impulsive-sound signal received from the multiple audio sensors 112 (depicted as audio sensors 112(1) to 112(n)). As depicted, the sub-band reverb characteristic module 202 provides the reverb characteristic 270 determined for each impulsive-sound signal to a reverb characteristic combiner module 410.

The reverb characteristic combiner module 410 combines the received reverb parameters to provide a robust reverb characteristic 420 of the environment (e.g., a reverb characteristic generated based on inputs provided by multiple audio sensors) where the signals are recorded by the audio sensors 112(1) to 112(n). In some implementations, the reverb characteristic combiner module 410 combines the received reverb parameters according to a mean or median value of the combined reverb parameters.

FIG. 4B is an example architecture 450 for the described reverb measuring system where the impulsive-sound signals captured by the audio sensors 112(1) to 112(n) are received by the impulsive-sound signal combiner module 460, combined, and then provided to the sub-band reverb characteristic module 202. In an example implementation, the impulsive-sound signal combiner module 460 combines the impulsive-sound signals via maximum ratio combining (MRC) algorithm where each impulsive signal is weighted according to a signal-to-noise ratio (SNR) and then summated. Such an approach maximizes the overall SNR by emphasizing signals with higher SNRs while suppressing those with lower SNRs. The sub-band reverb characteristic module 202 generates robust reverb characteristic 420 of the environment based on the received input and according to the description above.

FIG. 5 depicts an example environment 500 that can be employed to execute implementations of the present disclosure. The example environment 500 includes computing devices 502, 504, 506, 508; a back-end system 530, and a communication network 510. The communication network 510 may include wireless and wired portions. In some cases, the communication network 510 is implemented using one or more existing networks, for example, a cellular network, the Internet, a land mobile radio (LMR) network, a BLUETOOTH network, a wireless local area network (for example, Wi-Fi), a wireless accessory Personal Area Network (PAN), a Machine-to-machine (M2M) network, and a telephone network. The communication network 510 may also include future developed networks. In some implementations, the communication network 510 includes the Internet, an intranet, an extranet, or an intranet and/or extranet that is in communication with the Internet. In some implementations, the communication network 510 includes a telecommunication or a data network.

In some implementations, the communication network 510 connects web sites, devices (e.g., the computing devices 502, 504, 506, and 508) and back-end systems (e.g., the back-end system 530). In some implementations, the network 510 can be accessed over a wired or a wireless communications link. For example, mobile computing devices (e.g., the smartphone device 502 and the tablet device 506), can use a cellular network to access the network 510.

In some examples, the users 522, 524, 526, and 528 interact with the system through a graphical user interface (GUI) (e.g., the user interface 725 described below with reference to FIG. 7) or client application that is installed and executing on their respective computing devices 502, 504, 506, or 508. In some examples, the computing devices 502, 504, 506, and 508 provide viewing data (e.g., a prompt to generate an impulsive sound) to screens with which the users 522, 524, 526, and 526, can interact. In some examples, the computing devices 502, 504, 506, and 508 provide a series of impulsive-sound signals recorded within an environment to the back-end system 530, which is configured to determine a reverb characteristic for the environment according to implementations of the present disclosure. In some examples, the computing devices 502, 504, 506, and 508 are configured to determine a reverb characteristic for the environment according to implementations of the present disclosure.

In some implementations, the computing devices 502, 504, 506 and 508 are sustainably similar to the computing device 710 described below with reference to FIG. 7. The computing devices 502, 504, 506, and 508 may include (e.g., may each include) any appropriate type of computing device, such as a desktop computer, a laptop computer, a handheld computer, a tablet computer, a personal digital assistant (PDA), an AR/VR device, a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

Four user computing devices 502, 504, 506 and 508 are depicted in FIG. 5 for simplicity. In the depicted example environment 500, the computing device 502 is depicted as a smartphone, the computing device 504 is depicted as a tablet-computing device, the computing device 506 is depicted as a desktop computing device, and the computing device 508 is depicted as an AR/VR/XR device. It is contemplated, however, that implementations of the present disclosure can be realized with any of the appropriate computing devices, such as those mentioned previously. Moreover, implementations of the present disclosure can employ any number of devices.

In some implementations, the back-end system 530 includes at least one server device 532 and optionally, at least one data store 534. In some implementations, the server device 532 is sustainably similar to computing device 710 depicted below with reference to FIG. 7. In some implementations, the server device 532 is a server-class hardware type device. In some implementations, the back-end system 530 includes computer systems using clustered computers and components to function as a single pool of seamless resources when accessed through the communications network 510. For example, such implementations may be used in data center, cloud computing, storage area network (SAN), and network attached storage (NAS) applications. In some implementations, the back-end system 530 is deployed using a virtual machine(s).

In some implementations, the data store 534 is a repository for persistently storing and managing collections of data. Example data stores that may be employed within the described system include data repositories, such as a database as well as simpler store types, such as files, emails, and so forth. In some implementations, the data store 534 includes a database. In some implementations, a database is a series of bytes or an organized collection of data that is managed by a database management system (DBMS).

In some implementations, the back-end system 530 hosts one or more computer-implemented services provided by the described system with which users 522, 524, 526, and 526 can interact using the respective computing devices 502, 504, 506, and 508. For example, in some implementations, the back-end system 530 is configured to determine a reverb characteristic for an environment according to implementations of the present disclosure.

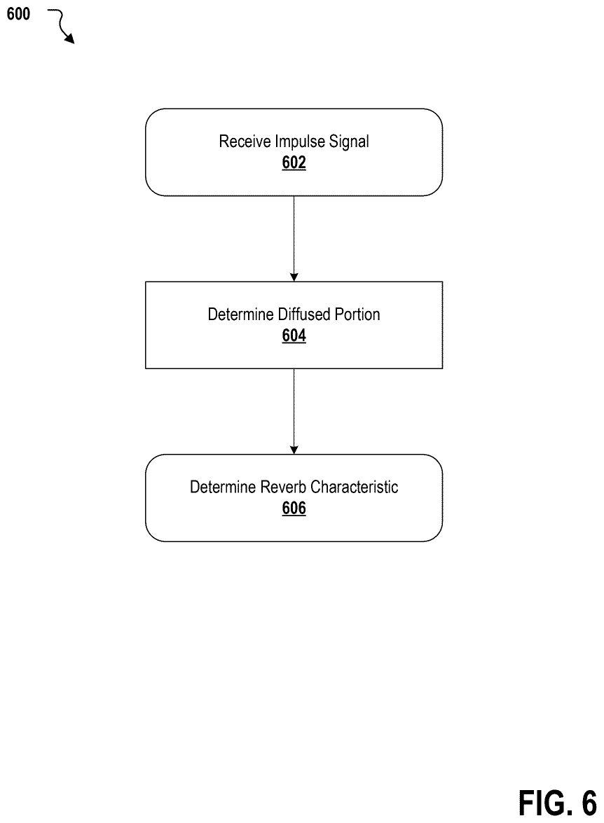

FIG. 6 depicts a flowchart of an example process 600 that can be implemented by implementations of the present disclosure. The example process 600 can be implemented by systems and components described with reference to FIGS. 1, 2, 4A-5, and 7. The example process 600 generally shows in more detail how a reverb characteristic for an environment is determined based on impulsive-sound signals recorded within the environment.

For clarity of presentation, the description that follows generally describes the example process 600 in the context of FIGS. 1-5 and 7. However, it will be understood that the process 600 may be performed, for example, by any other suitable system, environment, software, and hardware, or a combination of systems, environments, software, and hardware as appropriate. In some implementations, various operations of the process 600 can be run in parallel, in combination, in loops, or in any order.

At 602, an impulsive-sound signal is received from an audio sensor. The impulsive-sound signal includes a range of frequencies capturing an impulsive sound. The impulsive sound including sound waves emitted from a source within an environment. In some implementations, a prompt having instructions for generating the impulsive sound is provided via a display. In some implementations, the audio sensor is a microphone, a piezoelectric sensor, or a capacitive sensor. In some implementations, the range of frequencies are from 20 hertz to 20 kilohertz.

From 602, the process 600 proceeds to 604 where a diffused portion of the impulsive sound is determined based on a threshold value. The diffused portion includes the sound waves emitted from the source and reflected from the environment. In some implementations, determining the diffused portion of the impulsive sound includes converting the range of frequencies to a scale plotting a decay over time of a measure of the sound waves, and determining the diffused portion according to the scale.

In some implementations, converting the range of frequencies to the scale includes determining a plurality of Fourier spectra for a plurality of segments of the impulsive-sound signal, plotting the plurality of Fourier spectra as a function of time, and determining a log of a magnitude of the plotted Fourier spectra. In some implementations, the measure of the sound waves of the impulsive sound is in decibels. In some implementations, determining the diffused portion according to the scale includes determining a maximum value of the sound waves, determining an initial portion of the impulsive sound between the maximum value and a starting location of the diffused portion, and determining a background portion of the impulsive sound. In some implementations, the background portion of the impulsive sound is determined based on a measure of background noise within the environment.

In some implementations, the threshold value includes a set amount of the measure of the sound waves. In some implementations, the starting location of the diffused portion is calculated based on the maximum value of the measure of the sound waves and the threshold value. In some implementations, the threshold value includes a value for a rate of decay over time of the measure of the sound waves. In some implementations, determining the diffused portion of the scale includes determining an ending location of the diffused portion based on a starting location of the background portion.

In some implementations, determining the diffused portion of the scale includes determining the ending location of the diffused portion based on the starting location of the background portion and an offset value. In some implementations, the offset value is set between one and ten decibels. In some implementations, the magnitude of the diffused portion is determined based on the starting location of the diffused portion and the ending location of the diffused portion. In some implementations, an extrapolated diffused portion is determined by applying a linear regression model to the diffused portion and based on a measure of decay of a reverb parameter associated with the reverb characteristic and a distance between on the starting location of the diffused portion and the ending location of the diffused portion. In some implementations, the reverb characteristic of the environment is determined based on a magnitude of the diffused portion and the extrapolated diffused portion. In some implementations, applying the linear regression model includes applying a linear fit to the diffused portion in log scale.

From 604, the process 600 proceeds to 606 where a reverb characteristic of the environment is determined based on a magnitude of the diffused portion. In some implementations, a plurality of spatial audio sounds is rendered based on the reverb characteristic. In some implementations, a robust reverb characteristic of the environment is determined based on the magnitude of the diffused portion and a plurality of impulsive-sound signals received from a plurality of other audio sensors. In some implementations, the reverb characteristic of the environment includes a measure of how sound travels and decays within the environment. In some implementations, the reverb characteristic includes at least one reverb parameter. In some implementations, the at least one reverb parameter includes a reverberation time-60 value or a reverberation time-20 value. From 606, the process 600 ends.

FIG. 7 depicts an example computing system 700 that includes a computer or computing device 710 that can be programmed or otherwise configured to implement systems or methods of the present disclosure. For example, the computing device 710 can be programmed or otherwise configured to implement the processes 300 or 600. In some cases, the computing device 710 includes an operating system configured to perform executable instructions. The operating system is, for example, software, including programs and data that manages the device's hardware and provides services for execution of applications.

In the depicted implementation, the computer or computing device 710 includes an electronic processor (also “processor” and “computer processor” herein) 712, such as a central processing unit (CPU) or a graphics processing unit (GPU), which is optionally a single core, a multi core processor, or a plurality of processors for parallel processing. The depicted implementation also includes memory 717 (e.g., random-access memory, read-only memory, flash memory), electronic storage unit 714 (e.g., hard disk or flash), communication interface module 715 (e.g., a network adapter or modem) for communicating with one or more other systems, and peripheral devices 716, such as cache, other memory, data storage, microphones, speakers, and the like. In some implementations, the memory 717, storage unit 714, communication interface module 715 and peripheral devices 716 are in communication with the electronic processor 712 through a communication bus (shown as solid lines), such as a motherboard. In some implementations, the bus of the computing device 710 includes multiple buses. The above-described hardware components of the computing device 710 can be used to facilitate, for example, an operating system and operations of one or more applications executed via the operating system. For example, a virtual representation of space may be provided via the user interface 725. In some implementations, the computing device 710 includes more or fewer components than those illustrated in FIG. 7 and performs functions other than those described herein.

In some implementations, the memory 717 and storage unit 714 include one or more physical apparatuses used to store data or programs on a temporary or permanent basis. In some implementations, the memory 717 is volatile memory and can use power to maintain stored information. In some implementations, the storage unit 714 is non-volatile memory and retains stored information when the computer is not powered. In further implementations, memory 717 or storage unit 714 is a combination of devices such as those disclosed herein. In some implementations, memory 717 or storage unit 714 is distributed across multiple machines such as a network-based memory or memory in multiple machines performing the operations of the computing device 710.

In some cases, the storage unit 714 is a data storage unit or data store for storing data. In some instances, the storage unit 714 stores files, such as drivers, libraries, and saved programs. In some implementations, the storage unit 714 stores data received by the device (e.g., audio data). In some implementations, the computing device 710 includes one or more additional data storage units that are external, such as located on a remote server that is in communication through a network (e.g., the communications network 510 described above with reference to FIG. 5).

In some implementations, platforms, systems, media, and methods as described herein are implemented by way of machine or computer executable code stored on an electronic storage location (e.g., non-transitory computer readable storage media) of the computing device 710, such as, for example, on the memory 717 or the storage unit 714. In further implementations, a computer readable storage medium is optionally removable from a computer. Non-limiting examples of a computer readable storage medium include compact disc read-only memories (CD-ROMs), digital versatile discs (DVDs), flash memory devices, solid state memory, magnetic disk drives, magnetic tape drives, optical disk drives, cloud computing systems and services, and the like. In some cases, the computer executable code is permanently, substantially permanently, semi-permanently, or non-transitorily encoded on the media.

In some implementations, the electronic processor 712 is configured to execute the code. In some implementations, the machine executable or machine-readable code is provided in the form of software. In some examples, during use, the code is executed by the electronic processor 712. In some cases, the code is retrieved from the storage unit 714 and stored on the memory 717 for ready access by the electronic processor 712. In some situations, the storage unit 714 is precluded, and machine-executable instructions are stored on the memory 717.

In some cases, the electronic processor 712 is a component of a circuit, such as an integrated circuit. One or more other components of the computing device 710 can be optionally included in the circuit. In some cases, the circuit is an application specific integrated circuit (ASIC) or a field programmable gate arrays (FPGAs). In some cases, the operations of the electronic processor 712 can be distributed across multiple machines (where individual machines can have one or more processors) that can be coupled directly or across a network.

In some cases, the computing device 710 is optionally operatively coupled to a communication network, such as the communication network 510 described above with reference to FIG. 5, via the communication interface module 715, which may include digital signal processing circuitry. Communication interface module 715 may provide for communications under various modes or protocols, such as global system for mobile (GSM) voice calls, short message/messaging service (SMS), enhanced messaging service (EMS), or multimedia messaging service (MMS) messaging, code-division multiple access (CDMA), time division multiple access (TDMA), wideband code division multiple access (WCDMA), CDMA2000, or general packet radio service (GPRS), among others. Such communication may occur, for example, through a transceiver. In addition, short-range communication may occur, such as using a BLUETOOTH, WI-FI, or other such transceiver.

In some cases, the computing device 710 includes or is in communication with one or more output devices 720. In some cases, the output device 720 includes a display to send visual information to a user. In some cases, the output device 720 is a touch sensitive display that combines a display with a touch sensitive element that is operable to sense touch inputs as and functions as both the output device 720 and the input device 730. In still further cases, the output device 720 is a combination of devices such as those disclosed herein. In some cases, the output device 720 displays a user interface 725 generated by the computing device.

In some cases, the computing device 710 includes or is in communication with one or more input devices 730 that are configured to receive information from a user. In some cases, the input device 730 is a keyboard. In some cases, the input device 730 is a keypad (e.g., a telephone-based keypad). In some cases, the input device 730 is a cursor-control device including, by way of non-limiting examples, a mouse, trackball, trackpad, joystick, game controller, or stylus. In some cases, as described above, the input device 730 is a touchscreen or a multi-touchscreen. In other cases, the input device 730 is a microphone to capture voice or other sound input. In other cases, the input device 730 is an imaging device such as a camera. In still further cases, the input device is a combination of devices such as those disclosed herein.

It should also be noted that a plurality of hardware and software-based devices, as well as a plurality of different structural components may be used to implement the described examples. In addition, implementations may include hardware, software, and electronic components or modules that, for purposes of discussion, may be illustrated and described as if most of the components were implemented solely in hardware. In some implementations, the electronic-based aspects of the disclosure may be implemented in software (e.g., stored on non-transitory computer-readable medium) executable by one or more processors, such as electronic processor 712. As such, it should be noted that a plurality of hardware and software-based devices, as well as a plurality of different structural components may be employed to implement various implementations.

It should also be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Moreover, various implementations of the systems and techniques described herein can be realized in digital electronic circuitry, integrated circuitry, specially designed ASICS (application specific integrated circuits), computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include computer readable or machine instructions for a programmable electronic processor and can be implemented in a high-level procedural or object-oriented programming language, or in assembly/machine language. As used herein, the terms “machine-readable medium” and “computer-readable medium” refers to any computer program product, apparatus or device (e.g., magnetic discs, optical disks, memory, Programmable Logic Devices (PLDs)) used to provide machine instructions or data to a programmable processor, including a machine-readable medium that receives machine instructions as a machine-readable signal. The term “machine-readable signal” refers to any signal used to provide machine instructions or data to a programmable processor.

The functionality of the computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, or add-ons, or combinations thereof.

Unless otherwise defined, the technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

A number of implementations have been described. Nevertheless, it will be understood that various modifications may be made without departing from the spirit and scope of the disclosed implementations. While preferred implementations of the present disclosure have been shown and described herein, it will be obvious to those skilled in the art that such implementations are provided by way of example only. Numerous variations, changes, and substitutions will now occur to those skilled in the art without departing from the described system. It should be understood that various alternatives to the implementations described herein may be employed in practicing the described system.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example implementations does not define or constrain this disclosure. Other changes, substitutions, and alterations are also possible without departing from the spirit and scope of this disclosure.

What is claimed is:

1. A method comprising:
receiving, from an audio sensor, an impulsive-sound signal comprising a range of frequencies capturing an impulsive sound, the impulsive sound comprising sound waves emitted from a source within an environment;
determining, based on a threshold value, a diffused portion of the impulsive sound comprising the sound waves emitted from the source and reflected from the environment; and
determining a reverb characteristic of the environment based on a magnitude of the diffused portion.

2. The method of claim 1, wherein determining the diffused portion of the impulsive sound includes:
converting the range of frequencies to a scale plotting a decay over time of a measure of the sound waves, and
determining the diffused portion according to the scale.

3. The method of claim 2, wherein converting the range of frequencies to the scale includes:
determining a plurality of Fourier spectra for a plurality of segments of the impulsive-sound signal,
plotting the plurality of Fourier spectra as a function of time, and
determining a log of a magnitude of the plotted Fourier spectra.

4. The method of claim 2, wherein determining the diffused portion according to the scale:
determining a maximum value of the sound waves,
determining an initial portion of the impulsive sound between the maximum value and a starting location of the diffused portion, and
determining a background portion of the impulsive sound.

5. The method of claim 4, further comprising determining the background portion of the impulsive sound based on a measure of background noise within the environment.

6. The method of claim 4, wherein the threshold value comprises a set amount of the measure of the sound waves, and wherein the starting location of the diffused portion is calculated based on the maximum value of the measure of the sound waves and the threshold value.

7. The method of claim 4, wherein the threshold value comprises a value for a rate of decay over time of the measure of the sound waves.

8. The method of claim 4, wherein determining the diffused portion of the scale includes:
determining an ending location of the diffused portion based on a starting location of the background portion.

9. The method of claim 8, wherein determining the diffused portion of the scale includes:
determining the ending location of the diffused portion based on the starting location of the background portion and an offset value.

10. The method of claim 8, further comprising:
determining the magnitude of the diffused portion based on the starting location of the diffused portion and the ending location of the diffused portion;
determining, portion by applying a linear regression model to the diffused portion, an extrapolated diffused based on a measure of decay of a reverb parameter associated with the reverb characteristic and a distance between on the starting location of the diffused portion and the ending location of the diffused portion, wherein applying the linear regression model includes applying a linear fit to the diffused portion in log scale; and
determining the reverb characteristic of the environment based on a magnitude of the diffused portion and the extrapolated diffused portion.

11. The method of claim 1, further comprising:
rendering a plurality of spatial audio sounds based on the reverb characteristic.

12. The method of claim 1, further comprising:
determining a robust reverb characteristic of the environment based on the magnitude of the diffused portion and a plurality of impulsive-sound signals received from a plurality of other audio sensors.

13. The method of claim 1, further comprising:
providing a prompt, via a display, comprising instructions for generating the impulsive sound.

14. The method of claim 1, wherein the reverb characteristic of the environment comprises a measure of how sound travels and decays within the environment.

15. The method of claim 1, wherein the audio sensor comprises a microphone, a piezoelectric sensor, or a capacitive sensor.

16. The method of claim 1, wherein the reverb characteristic comprises at least one reverb parameter.

17. The method of claim 16, wherein the at least one reverb parameter includes a reverberation time-60 value or a reverberation time-20 value.

18. A computer-readable medium storing instructions that when executed by an electronic processor cause the electronic processor to execute operations, the operations comprising:
receiving, from an audio sensor, an impulsive-sound signal comprising a range of frequencies capturing an impulsive sound, the impulsive sound comprising sound waves emitted from a source within an environment;
determining, based on a threshold value, a diffused portion of the impulsive sound comprising the sound waves emitted from the source and reflected from the environment; and
determining a reverb characteristic of the environment based on a magnitude of the diffused portion.

19. The computer-readable medium of claim 18, wherein determining the diffused portion of the impulsive sound includes:
converting the range of frequencies to a scale plotting a decay over time of a measure of the sound waves, and
determining the diffused portion according to the scale.

20. The computer-readable medium of claim 19, wherein determining the diffused portion according to the scale includes:
determining a maximum value of the sound waves,
determining an initial portion of the impulsive sound between the maximum value and a starting location of the diffused portion, and
determining a background portion of the impulsive sound.

21. The computer-readable medium of claim 20, wherein the threshold value comprises a set amount of the measure of the sound waves, and wherein the starting location of the diffused portion is calculated based on the maximum value of the measure of the sound waves and the threshold value.

22. A system comprising:
an audio sensor; and
an electronic processor configured to:
receive, from the audio sensor, an impulsive-sound signal comprising a range of frequencies capturing an impulsive sound, the impulsive sound comprising sound waves emitted from a source within an environment;
determine, based on a threshold value, a diffused portion of the impulsive sound comprising the sound waves emitted from the source and reflected from the environment; and
determine a reverb characteristic of the environment based on a magnitude of the diffused portion.

23. The system of claim 22, wherein the electronic processor configured to determine the diffused portion of the impulsive sound by:
converting the range of frequencies to a scale plotting a decay over time of a measure of the sound waves, and
determining the diffused portion according to the scale.

24. The system of claim 23, wherein electronic processor configured to determine the diffused portion according to the scale by:
determining a maximum value of the sound waves,
determining an initial portion of the impulsive sound between the maximum value and a starting location of the diffused portion, and
determining a background portion of the impulsive sound.

25. The system of claim 24, wherein the threshold value comprises a set amount of the measure of the sound waves, and wherein the starting location of the diffused portion is calculated based on the maximum value of the measure of the sound waves and the threshold value.
